(19) United States
(12) Patent Application Publication
(10) Pub. No.: US 2010/0138009 A1
(43) Pub. Date: Jun. 3, 2010

(54) Music Device Equipped with Image Display

(75) Inventors: Tatsuya Mitsugi, Tokyo (JP); Chikako Takeuchi, Hyogo (JP)

Correspondence Address: BIRCH STEWART KOLASCH & BIRCH, PO BOX 747, FALLS CHURCH, VA, 22040-0747, US

(73) Assignee: MITSUBISHI DENKI KABUSHIKI KAISHA, Tokyo (JP)

(21) Appl. No.: 11/884,306

(22) PCT Filed: Feb. 2, 2006
(86) PCT No.: PCT/JP2006/301789

§ 371 Date: Aug. 14, 2007

(30) Foreign Application Priority Data
May 24, 2005 (JP) 2005-151208

(51) Int. Cl. G06F 17/00

(52) U.S. Cl. 700/94

(57) ABSTRACT

A music device includes a characteristic extraction means 103 for extracting two or more characteristics included in music information from this music information, image generating means 105 to 111 each for generating an image which has variations which differ dependently upon each of the two or more characteristics extracted by the characteristic extraction means, and a monitor 112 for displaying the images generated by the image generating means.

### FIELD OF THE INVENTION

The present invention relates to a music device with an image display. More particularly, it relates to a technology for expressing music information as visual information.

### BACKGROUND OF THE INVENTION

Conventionally, a color converter for converting a sound signal by using a frequency-division assignment conversion method is known as an apparatus which outputs an image while associating it with a sound (for example, refer to patent reference 1). This color converter artificially associates a frequency spectrum of a sound, such as a musical sound, a voice, or a mechanical noise, with colors on an octave-by-octave basis, converting these colors into trichromatic electric signals and compositing these electric signals into a signal, converting the sound signal into variations in the colors by using the composite signal, and carries out a color demonstration corresponding to the sound or makes a prediction of dangers.

As another apparatus which associates a sound with an image and outputs the sound, a musical piece playback system which correctly analyzes a rhythm component included in musical piece data, and makes the analysis result be reflected in the display form of characters is known (for example, refer to patent reference 2). This musical piece playback system assigns favorite rhythm components to the characters in advance, respectively, and further assigns inherent pose expression abilities to the characters in advance, respectively. A sound-pressure-data generating unit then creates sound pressure data for each of two or more frequency bands from the musical piece data, and a frequency band specifying unit specifies a frequency band in which the rhythm beats most frequently. A rhythm estimating unit estimates a rhythm component on the basis of the time period of change in the sound pressure data of the specified frequency band. A character management unit changes the pose expression ability cumulatively according to the degree of matching between the estimated rhythm component and the favorite rhythm component. A display control unit changes the display pose of the character according to the pose expression ability when the musical piece data are played back.
[Patent reference 1] JP, 3-134696,A
[Patent reference 2] JP, 2000-250534,A

A problem with the sound-signal-to-color converter as disclosed in above-mentioned patent reference 1 is, however, that because the frequency spectrum of the sound signal is associated with only colors, it is deficient in the color demonstration of the sound signal. Therefore, it is desired that an apparatus which can express sound colorfully is provided.

Although the musical piece playback system disclosed in patent reference 2 can change the pose of a character according to the rhythm of a musical piece, it is desired that an apparatus which can express a character which has various poses, various colors, etc. according to the characteristics of a musical sound is provided.

The present invention is made in order to respond to the above-mentioned desires, and it is therefore an object of the present invention to provide a music device equipped with an image display which can display an image with a variety of representations according to the various characteristics of music (a musical piece).

### DISCLOSURE OF THE INVENTION

In accordance with the present invention, there is provided a music device equipped with an image display, the device including: a characteristic extraction means for extracting two or more characteristics included in music information from the music information; an image generating means for generating an image which has variations which differ dependently upon each of the two or more characteristics extracted by the characteristic extraction means; and a monitor for displaying the image generated by the image generating means.

The music device in accordance with the present invention is so constructed as to extract two or more characteristics included in music information from the music information, generate an image which has variations which differ dependently upon each of the two or more characteristics extracted, and display the image on the monitor. Therefore, the music device can display an image with a variety of representations according to the various characteristics of music (a musical piece). As a result, the user can enjoy visually an image outputted with a different representation according to music (a musical piece) when listening to the music.

### BRIEF DESCRIPTION OF THE FIGURES

FIG. 1 is a block diagram showing the structure of a music device equipped with an image display in accordance with embodiment 1 of the present invention;

FIG. 2 is a flow chart showing a main process of the music device equipped with an image display in accordance with embodiment 1 of the present invention;

FIG. 3 is a flow chart showing a Fourier transform process carried out by the music device equipped with an image display in accordance with embodiment 1 of the present invention;

FIG. 4 is a flow chart showing a character number increase-or-decrease judging process carried out by the music device equipped with an image display in accordance with embodiment 1 of the present invention;

FIG. 5 is a flow chart showing an inside-of-character drawing process carried out by the music device equipped with an image display in accordance with embodiment 1 of the present invention;

FIG. 6 is a flow chart showing a drawing process carried out by the music device equipped with an image display in accordance with embodiment 1 of the present invention;

FIG. 7 is a flow chart showing a process of starting an event timer which is carried out by the music device equipped with an image display in accordance with embodiment 1 of the present invention;

FIG. 8 is a flow chart showing a Fourier transform synchronous process carried out by the music device equipped with an image display in accordance with embodiment 1 of the present invention;

FIG. 9 is a flow chart showing a process by an increase-or-decrease rule defining means which is carried out by the music device equipped with an image display in accordance with embodiment 1 of the present invention;

FIG. 10 is a flow chart showing a process by a character number increase-or-decrease judgment means which is carried out by the music device equipped with an image display in accordance with embodiment 1 of the present invention;

FIG. 11 is a flow chart showing a process by a character drawing rule defining means which is carried out by the music device equipped with an image display in accordance with embodiment 1 of the present invention;

FIG. 12 is a flow chart showing a process in accordance with the character inside drawing means carried out by the music device equipped with an image display in accordance with embodiment 1 of the present invention;

FIG. 13 is a flow chart showing a process by a drawing means which is carried out by the music device equipped with an image display in accordance with embodiment 1 of the present invention;

FIG. 14 is a diagram showing an example of a frequency peak table for use in the music device equipped with an image display in accordance with embodiment 1 of the present invention;

FIG. 15 is a diagram showing an example of a face's part representation table for use in the music device equipped with an image display in accordance with embodiment 1 of the present invention; and

FIG. 16 is a diagram showing an example of a color definition table for use in the music device equipped with an image display in accordance with embodiment 1 of the present invention.

### BEST MODE OF CARRYING OUT THE INVENTION

Hereafter, in order to explain this invention in greater detail, the best mode of carrying out the invention will be described with reference to the accompanying drawings.

### Embodiment 1

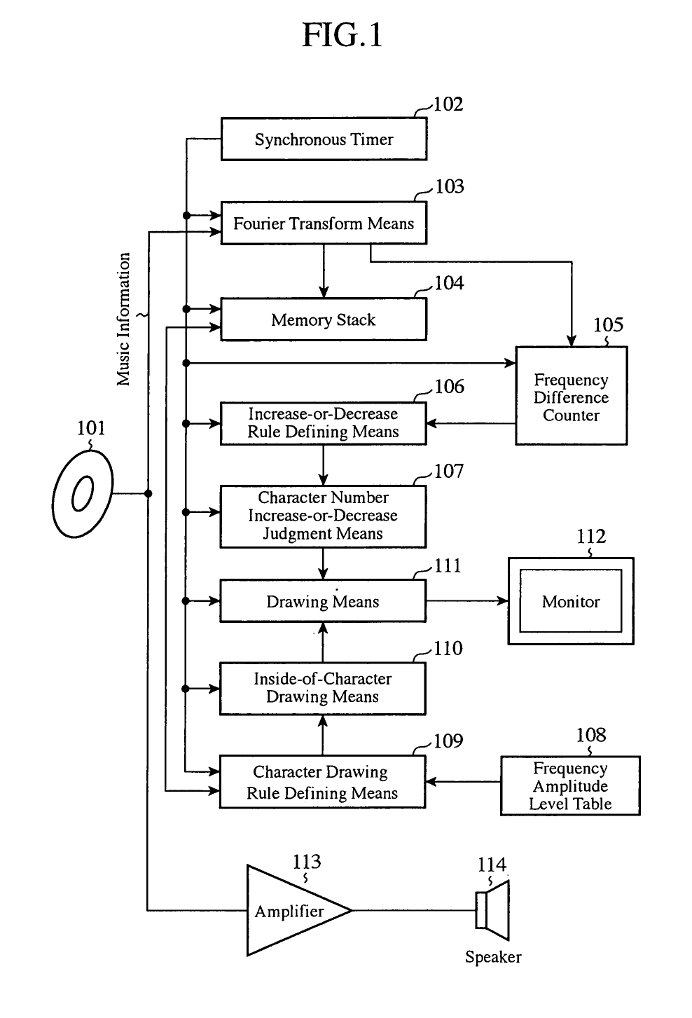

FIG. 1 is a block diagram showing the structure of a music device equipped with an image display in accordance with embodiment 1 of the present invention. This music device is provided with a music information storage means 101, a synchronous timer 102, a Fourier transform means 103, a memory stack 104, a frequency difference counter 105, an increase-or-decrease rule defining means 106, a character number increase-or-decrease judgment means 107, a frequency amplitude level table 108, a character drawing rule defining means 109, an inside-of-character drawing means 110, a drawing means 111, a monitor 112, an amplifier 113, and a speaker 114.

A characteristic extraction means of the present invention is implemented by the Fourier transform means 103. An image generating means of the present invention is implemented by the increase-or-decrease rule defining means 106, the character number increase-or-decrease judgment means 107, the frequency amplitude level table 108, the character drawing rule defining means 109, the inside-of-character drawing means 110, and the drawing means 111.

The music information storage means 101 is comprised of, for example, a storage which stores music information, such as a CD (Compact Disc), a DVD (Digital Versatile Disk), or an HDD (Hard Disk Drive). The music information stored in this music information storage means 101 is sent to both the Fourier transform means 103 and the amplifier 113.

As a time division, the synchronous timer 102 generates an event signal every 100 milliseconds (abbreviated as “msec” from here on), and sends it to the Fourier transform means 103, the memory stack 104, the frequency difference counter 105, the increase-or-decrease rule defining means 106, the character number increase-or-decrease judgment means 107, the drawing means 111, the inside-of-character drawing means 110, and the character drawing rule defining means 109. Each of these components runs in synchronization with the event signal from the synchronous timer 102.

The Fourier transform means 103 performs a Fourier transform on the music information sent from the music information storage means 101 in response to the event signal sent from the synchronous timer 102. As divisions of the speech frequency characteristics of a frequency spectrum acquired through this Fourier transform, the amplitude levels (in the unit mVs: millivolt second) of frequency components of frequencies 1 kHz, 2 kHz, 3 kHz, . . . , and 11 kHz (a frequency peak table can be prepared so that the speech frequency characteristics can be freely divided according to a music media format to be handled) are sent to the memory stack 104. The amplitude level of the frequency component of 900 Hz (the representative frequency of the voice band of the frequency spectrum acquired through the Fourier transform can be set up freely according to the music media format to be handled) is sent to the frequency difference counter 105 as the representative frequency of the voice band.

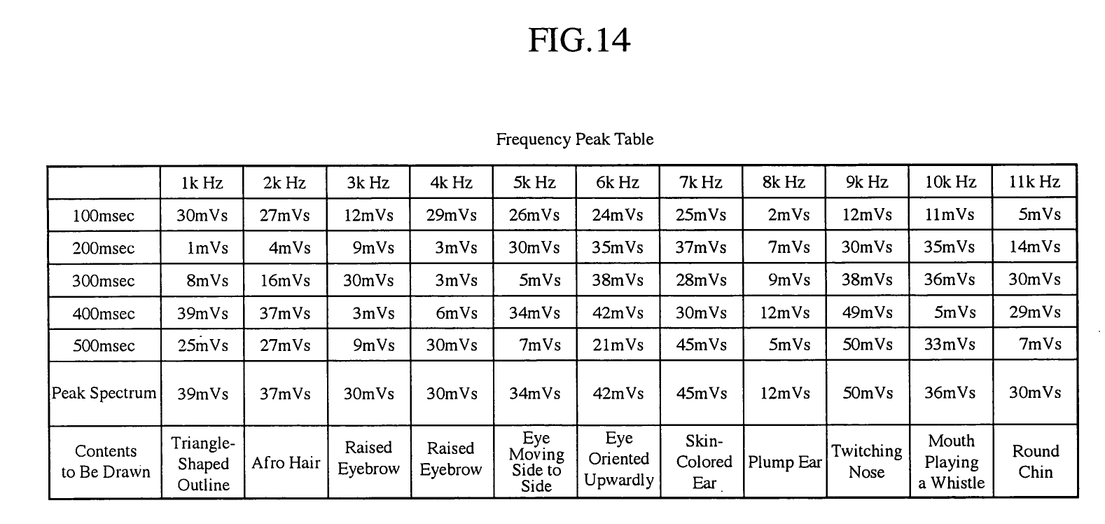

A frequency peak table as shown in FIG. 14 is formed in the memory stack 104. Five amplitude levels which are provided for each of the frequency components of the frequencies ranging from 1 kHz to 11 kHz which are sent every 100 m seconds from the Fourier transform means 103 are stored in turn in this frequency peak table in synchronization with the event signal sent from the synchronous timer 102. A peak spectrum field for storing, as a peak amplitude level, a maximum of the five amplitude levels which are provided for each of the frequency components and a contents-to-be-drawn field for associating the peak amplitude level with contents to be drawn are disposed in this frequency peak table. The contents of the peak-spectrum field and the contents-to-be-drawn field are set up by the character drawing rule defining means 109, as will be mentioned later.

The frequency difference counter 105 saves, as a constant D2, a constant D1 which it is storing at that time in synchronization with the event signal sent from the synchronous timer 102, and then stores, as the constant D1, the amplitude level of the frequency component of 900 Hz sent from the Fourier transform means 103. The frequency difference counter then calculates a change range of the amplitude level of the frequency component of 900 Hz which is measured every 100 msec, i.e., the absolute value of “constant D1−constant D2”, and stores it as a constant Y. This constant Y is sent to the increase-or-decrease rule defining means 106.

The increase-or-decrease rule defining means 106 determines a rule which defines an increase-or-decrease parameter in synchronization with the event signal sent from the synchronous timer 102 and according to the constant Y sent from the frequency difference counter 105, i.e., the degree of a change with time in the amplitude level of the specific frequency component acquired through the Fourier transform. To be more specific, in a case in which a length from an amplitude level of zero to the maximum is divided into 10 levels, the increase-or-decrease parameter is incremented by “1” when the constant Y sent from the frequency difference counter 105 is equal to or larger than “4”, the increase-or-decrease parameter is incremented by “2” when the constant Y is equal to or larger than “6”, and the increase-or-decrease parameter is incremented by “1” when the constant Y is smaller than “2.” The increase-or-decrease parameter calculated by this increase-or-decrease rule defining means 106 is sent to the character number increase-or-decrease judgment means 107.

The character number increase-or-decrease judgment means 107 defines increase or decrease in the number of characters which are to be outputted to the monitor 112 for the increase-or-decrease parameter of the rule defined by the increase-or-decrease rule defining means 106 in synchronization with the event signal sent from the synchronous timer 102. For example, when the current number of characters is “1”, the character number increase-or-decrease judgment means does not decrease the number of characters to a smaller one (minimum regulation). When the current number of characters is “10”, the character number increase-or-decrease judgment means does not increase the number of characters to a larger one (maximum regulation). When a result of accumulating the increase-or-decrease parameter exceeds “10”, the character number increase-or-decrease judgment means increases the number of characters and initializes the increase-or-decrease parameter (increase regulation). In contrast, when the result of accumulating the increase-or-decrease parameter is smaller than “−10”, the character number increase-or-decrease judgment means decreases the number of characters and initializes the increase-or-decrease parameter (subtraction regulation). The number C of characters determined by the control carried out by this character number increase-or-decrease judgment means 107 is sent to the drawing means 111.

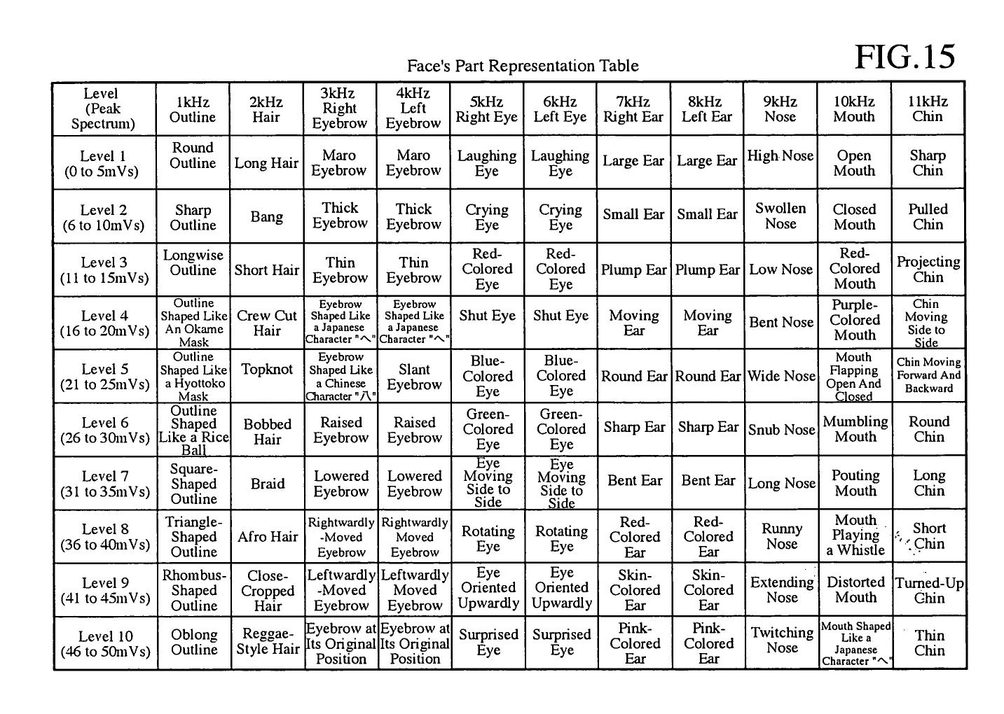

The frequency amplitude level table 108 stores part representation tables. In a part representation table, parts (a face's parts, body parts, or the like) of a character are assigned to the frequency components of frequencies ranging from 1 kHz to 11 kHz, and the representations of the parts of the character are determined respectively according to the peak amplitude levels (peak spectrum) of the frequency components. FIG. 15 shows an example of the part representation table of the face. In this example, an outline, hair, a right eyebrow, a left eyebrow, a right eye, a left eye, a right ear, a left ear, a nose, a mouth, and a chin are assigned sequentially to the frequency components of frequencies ranging from 1 Hz to 11 kHz in the order of increasing frequency. For example, representations, such as a laughing eye, a crying eye, a red-colored eye, and a shut eye, are assigned to the 10 levels ranging from zero to the maximum into which the amplitude level can be grouped, respectively. This frequency amplitude level table 108 is referred to by the character drawing rule defining means 109.

The character drawing rule defining means 109 captures the five amplitude levels of each of the frequency components of frequencies of 1 kHz to 11 kHz from the frequency peak table of the memory stack 104 in synchronization with the event signal sent from the synchronous timer 102. For each of the frequency components, the character drawing rule defining means calculates a maximum of the amplitude levels which are measured at predetermined intervals from 100 msec to 500 msec, and stores this calculation result, as a peak amplitude level, at a location specified by (the peak spectrum, PkHz) of the frequency peak table. In this case, P=1, 2, . . . , or 11, and, in the following explanation, P shows the same variable. The character drawing rule defining means then extracts contents to be drawn which correspond to the peak amplitude level from the part representation tables included in the frequency amplitude level table 108, and stores it at a location specified by (the contents-to-be-drawn, PkHz) of the frequency peak table. The character drawing rule defining means 109 reads the frequency peak table which has been created in the memory stack 104 in this way, and sends it to the inside-of-character drawing means 110.

The inside-of-character drawing means 110 processes parts to be drawn on the basis of the contents to be drawn which are stored at the location specified by (the contents to be drawn, PkHz) of the frequency peak table sent from the character drawing rule defining means 109 in synchronization with the event signal sent from the synchronous timer 102, and then sends the processed parts to the drawing means 111 as parts-to-be-drawn information.

The drawing means 11 draws a whole image including characters on the basis of the parts-to-be-drawn information sent from the inside-of-character drawing means 110 and the number C of characters sent from the character number increase-or-decrease judgment means 107 in synchronization with the event signal sent from the synchronous timer 102, and sends the whole image to the monitor 112 as a video signal. The monitor 112 displays the image according to the video signal sent from the drawing means 111.

The amplifier 113 generates a musical sound signal on the basis of the music information sent from the music information storage 101, and amplifies the musical sound signal. The musical sound signal amplified by this amplifier 113 is then sent to the speaker 114. The speaker 114 converts the musical sound signal sent from the amplifier 113 into a musical sound, and outputs it. As a result, music according to the music information stored in the music information storage means 101 is sounded out.

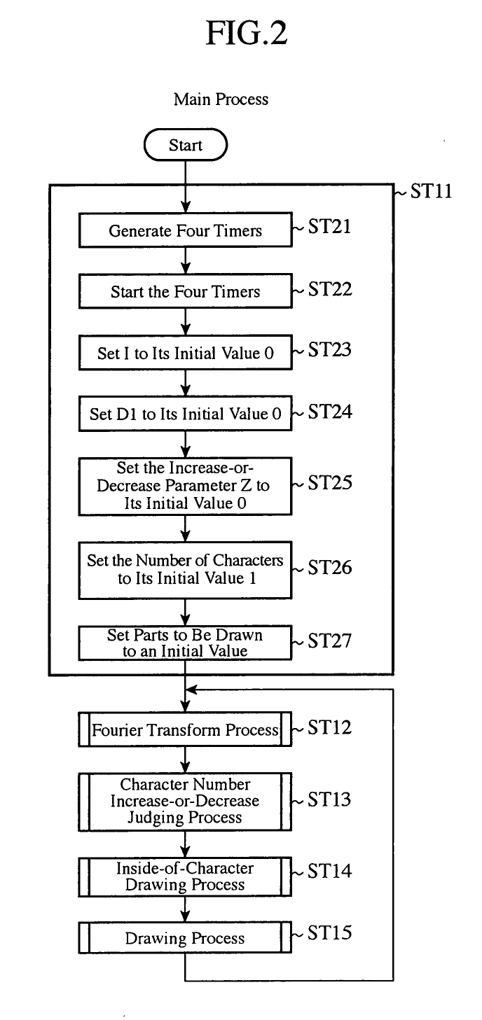

Next, the operation of the music device equipped with an image display in accordance with embodiment 1 of the present invention which is so constructed as mentioned above will be explained with reference to flowcharts shown in FIGS. 2 to 13.

FIG. 2 is a flow chart showing a main process of the music device equipped with an image display in accordance with embodiment 1 of the present invention. In the main process, an initialization process is carried out first (in step ST11). In this initialization process, four timers which are to be used respectively in a Fourier transform process, a character number increase-or-decrease judging process, an inside-of-character drawing process, and a drawing process, which will be mentioned later, are generated (in step ST21). The four timers generated in step ST11 are then started (in step ST22).

Next, a variable I which is used in order to count the number of times that a Fourier transform is carried out in the Fourier transform process which will be mentioned later is set to its initial value “0” (in step ST23). The constant D1 indicating the amplitude level of the frequency component of 900 Hz is then set to its initial value “0” (in step ST24). The increase-or-decrease parameter Z is then set to its initial value “0” (in step ST25). The number C of characters is then set to its initial value “1” (in step ST26). Apart to be drawn which the music device will start drawing is then set to its initial value (in step ST27).

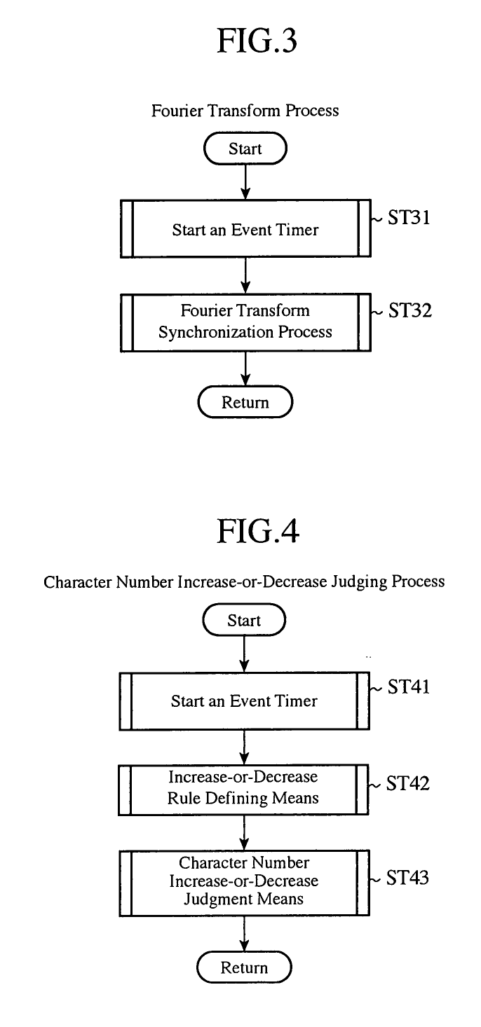

After the above-mentioned initialization process is completed, the Fourier transform process is then carried out (in step ST12). In this Fourier transform process, a process of starting an event timer is carried out first as shown in the flow chart of FIG. 3 (in step ST31). A Fourier transform synchronization process is then carried out (in step ST32). The details of these processes will be mentioned later. After that, the sequence is returned to the main process routine.

In the main process routine, the character number increase-or-decrease judging process is then carried out (in step ST13). In this character number increase-or-decrease judging process, as shown in the flow chart of FIG. 4, a process of starting an event timer is carried out first (in step ST41). A process using the increase-or-decrease rule defining means 106 is then carried out (in step ST42). A process using the character number increase-or-decrease judgment means 107 is then carried out (in step ST43). The details of these processes will be mentioned later. After that, the sequence is returned to the main process routine.

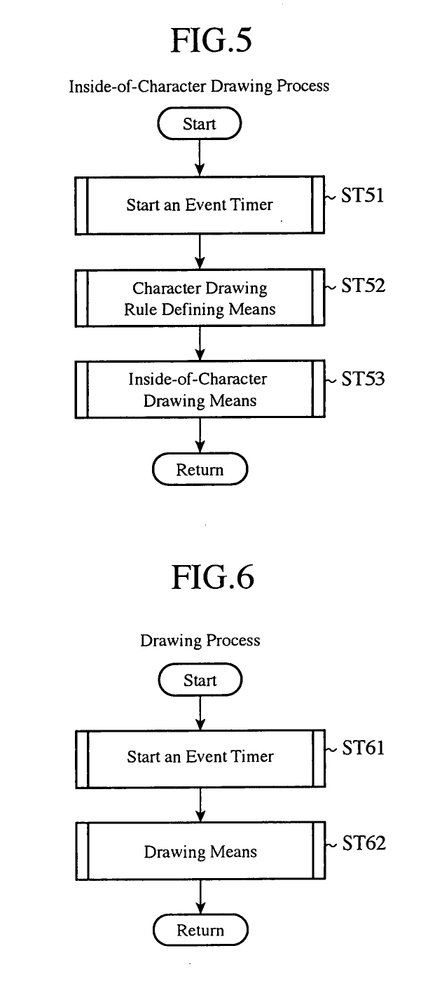

In the main process routine, the inside-of-character drawing process is then carried out (in step ST14). In this inside-of-character drawing process, as shown in the flow chart of FIG. 5, a process of starting an event timer is carried out first (in step ST51). A process using the character drawing rule defining means 109 is then carried out (in step ST52). A process using the character inside drawing means 110 is then carried out (in step ST53). The details of these processes will be mentioned later. After that, the sequence is returned to the main process routine.

In the main process routine, the drawing process is then carried out (in step ST15). In this drawing process, as shown in the flowchart of FIG. 6, a process of starting an event timer is carried out first (in step ST61). A process using the drawing means 111 is then carried out (in step ST62). The details of these processes will be mentioned later. After that, the sequence is returned to the main process routine. In the main process routine, after the drawing process is completed, the sequence is returned to step ST12. After that, the Fourier transform process, the character number increase-or-decrease judging process, the inside-of-character drawing process, and the drawing process, which are mentioned above, are carried out repeatedly.

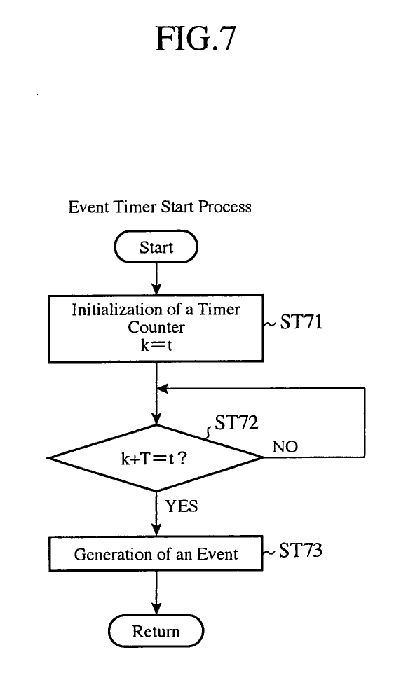

Next, the details of the process of starting the event timer which is carried out in step ST31 of the above-mentioned Fourier transform process (FIG. 3), in step ST41 of the character number increase-or-decrease judging process (FIG. 4), in step ST51 of the inside-of-character drawing process (FIG. 5), and in step ST61 of the drawing process (FIG. 6) will be explained with reference to the flowchart shown in FIG. 7. This process of starting the event timer is carried out by the synchronous timer 102.

In the process of starting the event timer, the count t of the timer counter is initialized to a value k first (in step ST71). Whether a value which is obtained by adding a predetermined event starting constant T which is different according to the function to the value k becomes equal to the count t of the timer counter is then checked to see (in step ST72). In this step ST72, when it is judged that the obtained value does become equal to the count t of the timer counter, this step ST72 is carried out repeatedly. When it is then judged that the obtained value becomes equal to the count t of the timer counter while step ST72 is carried out repeatedly, an event signal is produced (in step ST73). After that, the sequence is returned to a routine called.

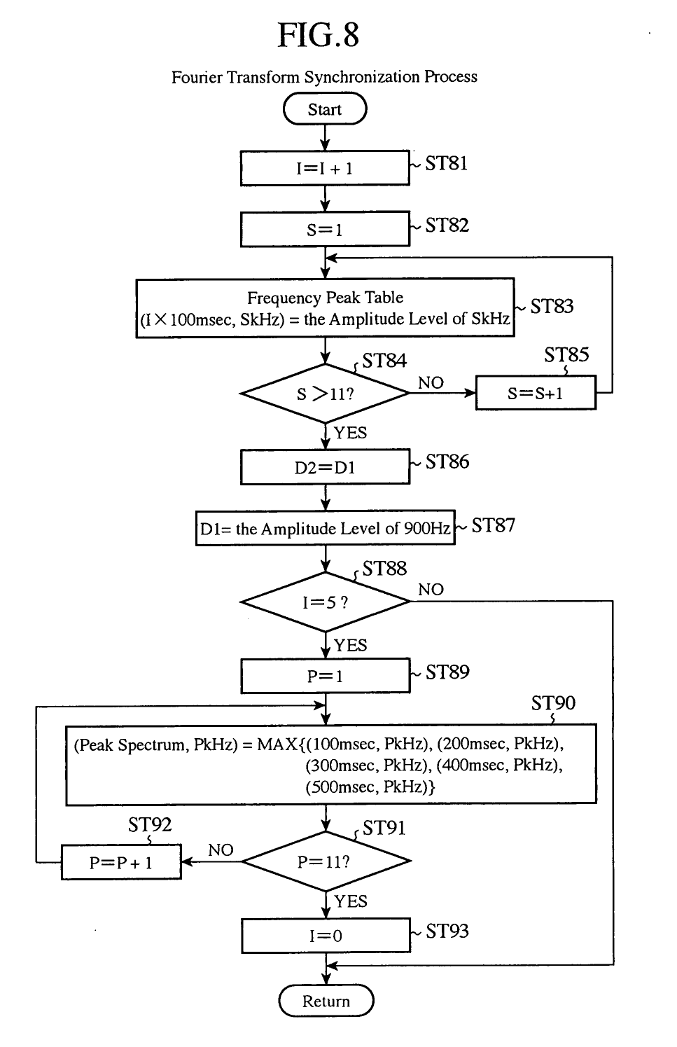

Next, the details of the Fourier transform synchronization process carried out in step ST32 of the above-mentioned Fourier transform process (refer to FIG. 3) will be explained with reference to the flow chart shown in FIG. 8. In the Fourier transform synchronization process, the variable I is incremented (+1) first (in step ST81). A variable S which defines the frequency component to be processed is then initialized to “1” (in step ST82). The Fourier transform is then carried out by the Fourier transform means 103, and the amplitude level of a frequency component of SkHz which is acquired through this Fourier transform is stored at a location specified by (I×100 msec, SkHz) of the frequency peak table formed in the memory stack 104 (in step ST83).

Whether or not the variable S is larger than “11” is then checked to see 8 step ST84). When, in this step ST84, it is judged that that the variable S is not larger than “11”, i.e., the variable S is equal to or smaller than “11”, the variable S is incremented (+1) (in step ST85). After that, the sequence is returned to step ST83 and the above-mentioned process is repeated. When, in step ST84, it is judged that the variable S becomes larger than “11” while the above-mentioned process is carried out repeatedly, it is judged that the processes corresponding to all the frequency components have been completed, and the value of the constant D1 in the frequency difference counter 105 is moved to the constant D2 (in step ST85). The amplitude level of the frequency component of 900 Hz which is acquired through the Fourier transform is then set to the constant D1 (in step ST87).

Whether or not the variable I is “5” is then checked to see (in step ST88). When, in this step ST88, it is judged that variable I is not “5”, it is judged that the Fourier transform has not been carried out five times and the sequence is returned to the Fourier transform process routine (FIG. 3). In contrast, when it is judged that the variable I is “5”, the variable P which defines the frequency component to be processed is initialized to “1” (in step ST89). A maximum of the amplitude levels stored at the locations specified by (100 msec, PkHz), (200 msec, PkHz), (300 msec, PkHz), (400 msec, PkHz), and (500 msec, PkHz) of the frequency peak table is then stored at the location specified by (the peak spectrum, PkHz) of the frequency peak table in the memory stack 104 (in step ST90).

Whether or not the variable P is “11” is then checked to see (in step ST91). When, in this step ST91, it is judged that the variable P is not “11”, the variable P is incremented (+1) (in step ST92). After that, the sequence is returned to step ST90 and the above-mentioned process is repeated. In contrast, when, in step ST91, it is judged that the variable P is “11”, the variable I is initialized to “0” (in step ST93). After that, the sequence is returned to the Fourier transform process routine (FIG. 3), and is further return to the main process routine.

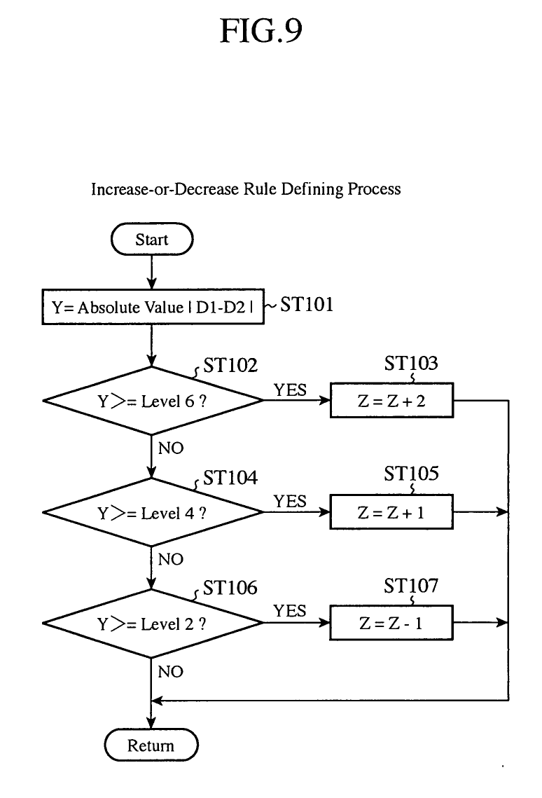

Next, the details of the process by the increase-or-decrease rule defining means 106 which is carried out in step ST42 of the above-mentioned character number increase-or-decrease judging process (FIG. 4) will be explained with reference to the flow chart shown in FIG. 9. In this process by the increase-or-decrease rule defining means 106, the absolute value of “D1−D2” outputted from the frequency difference counter 105 is set up as the constant Y first (in step ST101). Whether or not the constant Y shows level 6 or higher is checked to see (in step ST102). When, in this step ST102, it is judged that the constant Y shows level 6 or higher, “2” is added to the increase-or-decrease parameter Z (in step ST103). After that, the sequence is returned to the character number increase-or-decrease judging process routine (FIG. 4).

When, in above-mentioned step ST102, it is judged that the constant Y is lower than level 6, whether or not the constant Y is equal to or higher than level 4 is then checked to see (in step ST104). When, in this step ST104, it is judged that the constant Y is level 4 or higher, “1” is added to the increase-or-decrease parameter Z (in step ST105). After that, the sequence is returned to the character number increase-or-decrease judging process routine (FIG. 4).

When, in above-mentioned step ST104, it is judged that the constant Y is lower than level 4, whether or not the constant Y is equal to or higher than level 2 is then checked to see (in step ST106). When, in this step ST106, it is judged that the constant Y is level 2 or higher, “1” is added to the increase-or-decrease parameter Z (in step ST107). After that, the sequence is returned to the character number increase-or-decrease judging process routine (FIG. 4). When, in above-mentioned step ST106, it is judged that the constant Y is lower than level 2, the sequence is returned to the character number increase-or-decrease judging process routine (FIG. 4) without changing the increase-or-decrease parameter Z.

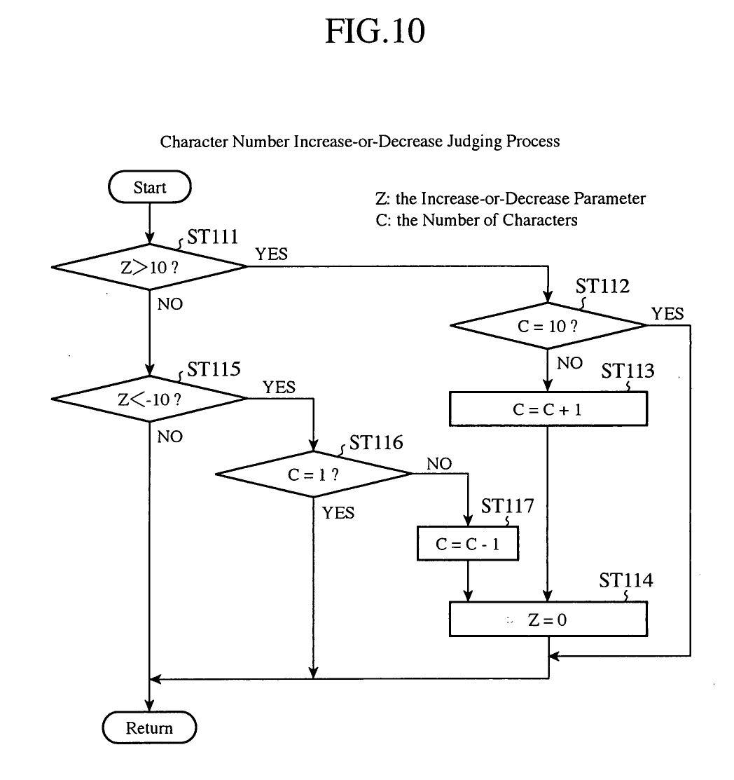

Next, the details of the process by the character number increase-or-decrease judgment means 107 which is carried out in step ST43 of the above-mentioned character number increase-or-decrease judging process (FIG. 4) will be explained with reference to the flow chart shown in FIG. 10. In this process by the character number increase-or-decrease judgment means 107, whether or not the increase-or-decrease parameter Z is larger than “10” is checked to see first (in step ST111). When, in this step ST111, it is judged that the increase-or-decrease parameter Z is larger than “10”, whether or not the number C of characters is “10” is checked to see (in step ST112).

When, in this step ST112, it is judged that the number C of characters is “10”, the sequence is returned to the character number increase-or-decrease judging process routine (FIG. 4) without further increasing the number of characters, and is further returned to the main process routine. When, in above-mentioned step ST112, it is judged that the number C of characters is not “10”, “1” is then added to the number C of characters (in step ST113). The increase-or-decrease parameter Z is then initialized to “0” (in step ST114). After that, the sequence is returned to the character number increase-or-decrease judging process routine (FIG. 4), and is further returned to the main process routine.

When, in above-mentioned step ST111, it is judged that the number C of characters is smaller than “10”, whether or not the increase-or-decrease parameter Z is smaller than “−10” is then checked to see (in step ST115). When, in this step ST115, it is judged that the increase-or-decrease parameter Z is smaller than “−10”, whether or not the number C of characters is “1” is checked to see (in step ST116). When, in this step ST116, it is judged that the number C of characters is not “1”, “1” is subtracted from the number C of characters (in step ST117). After that, the sequence is advanced to step ST114 and the increase-or-decrease parameter Z is then initialized to “0” as mentioned above.

When, in above-mentioned step ST116, it is judged that the number C of characters is “1”, the sequence is returned to the character number increase-or-decrease judging process routine (FIG. 4) without further decreasing the number of characters, and is further returned to the main process routine. When, in above-mentioned step ST115, it is judged that the increase-or-decrease parameter Z is equal to or larger than “−10”, the sequence is returned to the character number increase-or-decrease judging process routine (FIG. 4), and is further returned to the main process routine.

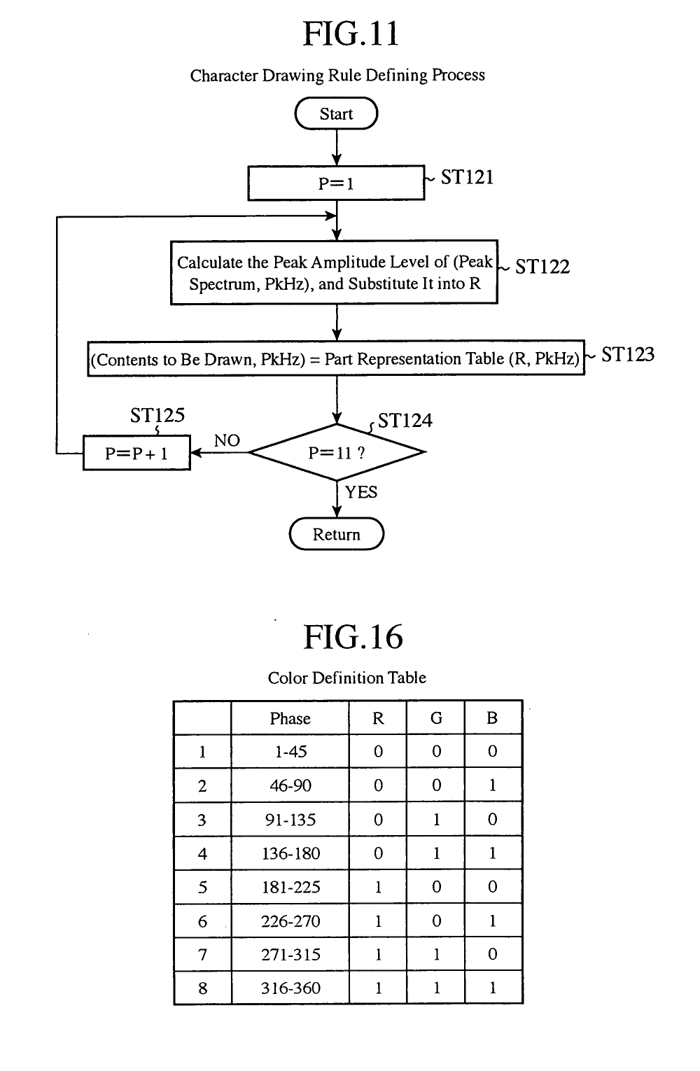

Next, the details of the process by the character drawing rule defining means 109 which is carried out in step ST52 of the above-mentioned inside-of-character drawing process (FIG. 5) will be explained with reference to the flow chart shown in FIG. 11. In this process by the character drawing rule defining means 109, the variable P is initialized to “1” first (in step ST121). A peak amplitude level at the location specified by (the peak spectrum, PkHz) of the frequency peak table in the memory stack 104 is then calculated, and is substituted into a constant R (in step ST122).

Contents at (R, PkHz) of the part representation tables in the frequency amplitude level table 108 are then set to the location specified by (the contents to be drawn, PkHz) of the frequency peak table in the memory stack 104 (in step ST123). Whether or not the variable P is “11” is then checked to see (in step ST124). When, in this step ST124, it is judged that the variable P is not “11”, “1” is added to the variable P (in step ST125). After that, the sequence is returned to step ST122. In contrast, when, in step ST124, it is judged that the variable P is “11”, the sequence is returned to the inside-of-character drawing process routine (FIG. 5).

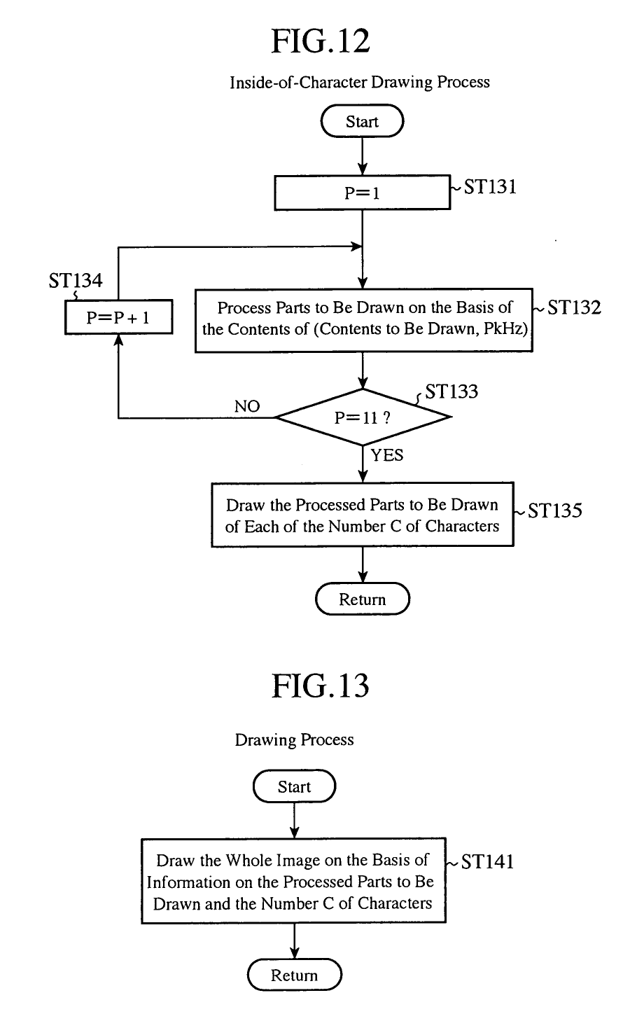

Next, the details of the process by the inside-of-character drawing means 110 which is carried out in step ST53 of the above-mentioned inside-of-character drawing process (FIG. 5) will be explained with reference to the flow chart shown in FIG. 12. In this process by the inside-of-character drawing means 110, the variable P is initialized to “1” first (in step ST131). Parts to be drawn are then processed on the basis of the contents at the location specified by (the contents to be drawn, PkHz) of the frequency peak table in the memory stack 104 (in step ST132).

Whether or not the variable P is “11” is then checked to see (in step ST133). When, in this step ST133, it is judged that the variable P is not “11”, “1” is added to the variable P (in step ST134). After that, the sequence is returned to step ST132 and the above-mentioned process is repeated. In contrast, when, in step ST133, it is judged that the variable P is “11”, information about the processed parts is delivered to the drawing means 111, and only the processed parts to be drawn of each of the number C of characters are drawn (in step ST135). After that, the sequence is returned to the inside-of-character drawing process routine (FIG. 5), and is further returned to the main process routine.

Next, the details of the process by the drawing means 111 which is carried out in step ST62 of the above-mentioned drawing process (FIG. 6) will be explained with reference to the flow chart shown in FIG. 13. In this process by the drawing means 111, drawing of the whole image containing characters is carried out on the basis of the information about the processed parts to be drawn and the number C of characters (in step ST191). After that, the sequence is returned to the drawing process routine (FIG. 5), and is further returned to the main process routine.

The above-explained music device equipped with an image display is so constructed as to determine the contents to be drawn according to frequency components and amplitude levels which it has acquired by performing a Fourier transform on the music information. The music device can be so constructed as to determine the contents to be drawn by further using the phases of the frequency components acquired through the Fourier transform.

For example, a color definition table for associating phases with chrominance signals (R, G, B), as shown in FIG. 16, can be prepared, and the inside-of-character drawing means 110 can be so constructed as to process the parts to be drawn on the basis of the contents to be drawn stored at the location specified by (the contents-to-be-drawn and PkHz) of the frequency peak table sent from the character drawing rule defining means 109 and a chrominance signal which corresponds to the phase of the frequency component of PkHz read from the color definition table in synchronization with the event signal sent from the synchronous timer 102, and send the processed parts to be drawn to the drawing means 111 as parts-to-be-drawn information. According to this structure, a further variety of representations of the characters can be provided. The drawing element which is associated with the phase is not limited to a color, and another drawing element like the thickness of a line to be drawn can be associated with the phase.

As previously explained, the music device equipped with an image display in accordance with embodiment 1 of the present invention is so constructed as to extract frequency components, amplitudes, and phases which form music information which defines music by performing a Fourier transform on the music information, generate a character which has variations which differ dependently upon each of the extracted frequency components, amplitudes, and phases, and display it on the monitor 112. Therefore, the music device can display an image including a character with a variety of representations according to the various characteristics of music (a musical piece). As a result, the user can enjoy visually an image containing an animation character displayed with a different representation according to music (a musical piece) when listening to the music.

### INDUSTRIAL APPLICABILITY

As mentioned above, the music device equipped with an image display in accordance with the present invention can display an image with a variety of representations according to the various characteristics of music (a musical piece) so as to enable the user to enjoy visually the music, and is therefore suitable for use in music apparatus with image display.

1. A music device equipped with an image display, characterized in that said device comprises:
a characteristic extraction means for extracting two or more characteristics included in music information which defines music from said music information;
an image generating means for generating an image which has variations which differ dependently upon each of the two or more characteristics extracted by said characteristic extraction means; and
a monitor for displaying the image generated by said image generating means.

2. The music device equipped with an image display according to claim 1, characterized in that the characteristic extraction means comprises a Fourier transform means for calculating at least two of a plurality of frequency components included in music information, and amplitudes and phases of the plurality of frequency components by performing a Fourier transform on the music information, and the image generating means generates an image which has variations which differ dependently upon at least the two of the plurality of frequency components, and the amplitudes and phases of the plurality of frequency components, which are calculated by said Fourier transform means.

3. The music device equipped with an image display according to claim 2, characterized in that the image generating means generates the image showing an animation character.

4. The music device equipped with an image display according to claim 3, characterized in that the image generating means comprises a character drawing rule defining means for associating parts of the character with the plurality of frequency components acquired by the Fourier transform means, respectively, and for determining a representation of each of the parts of said character according to an amplitude level of each of the plurality of frequency components, an inside-of-character drawing means for processing parts to be drawn on a basis of the representation determined by said character drawing rule defining means, and for outputting the parts to be drawn as parts-to-be-drawn information, and a drawing means for drawing the character on a basis of the parts-to-be-drawn information sent from said inside-of-character drawing means, and for outputting the character to the monitor.

5. The music device equipped with an image display according to claim 4, characterized in that the image generating means comprises an increase-or-decrease rule defining means for defining a rule which is used to set up an increase-or-decrease parameter for controlling a number of characters displayed on the monitor according to an amount of change with time in each of the plurality of frequency components acquired by the Fourier transform means, and a character number increase-or-decrease judgment means for controlling increase or decrease in the number of characters displayed on the monitor according to the increase-or-decrease parameter controlled according to the rule defined by said increase-or-decrease rule defining means.
